(19) United States
(12) Patent Application Publication
(10) Pub. No.: US 2014/0151221 A1
(43) Pub. Date: Jun. 5, 2014

(54) BIOSENSOR MODULE COMPRISING A BIOCOMPATIBLE ELECTRODE

(71) Applicant: NXP B.V., Eindhoven (NL)

(72) Inventors: Roel Daamen, Herkenbosch (NL); Viet Hoang Nguyen, Leuven (BE)

(73) Assignee: NXP B.V., Eindhoven (NL)

(21) Appl. No.: 14/069,003

(22) Filed: Oct. 31, 2013

(30) Foreign Application Priority Data
Dec. 3, 2012 (EP) 1295328.5

(51) Int. Cl. G01N 27/327

(52) U.S. Cl. CPC G01N 27/327
USPC 204/403.01; 216/13

(57) ABSTRACT

A method of manufacturing a module for a biosensor is disclosed. The method includes providing a substrate. The substrate includes a trench and a bond pad. The trench is filled with an electrically conductive material and the bond pad is arranged within the substrate. The method also includes removing a part of the electrically conductive material from the trench such that a recess is formed in a surface of the substrate, forming a biocompatible electrode in the recess, and removing a part of the substrate such that the bond pad is accessible through the surface of the substrate.

### FIELD OF THE INVENTION

The present invention relates to the field of biosensors, more specifically to the field of biosensors comprising one or more biocompatible electrodes for interacting with a biologic fluid sample as well as the field of manufacturing such biosensors.

### BACKGROUND

Attempts have been made to manufacture biosensor modules with very small biocompatible electrodes (diameter below 150 nm) formed from a noble metal (such as gold (Au)) on top of substrate trenches filled with an electrically conducting material, such as copper (Cu) or aluminum (Al). One such attempt involves forming the biocompatible electrodes together with bond pads by applying a copper CMP (chemical-mechanical planarization) step combined with a copper etch back step followed by gold deposition and a gold CMP (chemical-mechanical planarization) step.

However, due to the significant different in size between the small electrodes and the bond pads as well as several other factors, it is very hard to avoid a partial exposure of the copper of the bond pad during the CMP (dishing). Such exposure of the Cu to the chemical substances (slurries) used in the CMP process may cause immediate corrosion of the bond pad. Furthermore, use of a biosensor module with partially exposed copper in analysis of a biological sample may cause further corrosion and pollution of the sample.

There may be a need for an improved biosensor module with increased durability and reduced risk of sample pollution. Further, there may be a need for a method of manufacturing such an improved biosensor module.

### SUMMARY OF THE INVENTION

The above needs may be met by the subject matter according to the independent claims. Advantageous embodiments of the present invention are set forth in the dependent claims.

According to a first aspect, there is provided a method of manufacturing a module for a biosensor. The described method comprises (a) providing a substrate, the substrate comprising a trench and a bond pad, wherein the trench is filled with an electrically conductive material and the bond pad is arranged within the substrate, (b) removing a part of the electrically conductive material from the trench such that a recess is formed in a surface of the substrate, (c) forming a biocompatible electrode in the recess, and (d) removing a part of the substrate such that the bond pad is accessible through the surface of the substrate.

This aspect is based on the idea that the biocompatible electrode is formed on top of the electrically conductive material in the recess before a part of the substrate is removed to provide access to the bond pad within the substrate. Thereby, the bond pad is not exposed to the process of forming the biocompatible electrodes. Thus, the risk that corrosion of the bond pad will occur during manufacture is significantly reduced.

In the present context, the term “substrate” may particularly denote a dielectric material, such as silicon oxide or aluminum oxide, which besides the electrode and the bond pad may support or hold various semiconductor components and integrated circuits designed to provide electronic functions relating to a biosensor.

In the present context, the term “trench” may particularly denote an elongate cut-out or cavity in a surface of the substrate.

In the present context, the term “bond pad” may particularly denote a body of electrically conductive material arranged to provide electrical contact between components of the substrate and other devices.

In the present context, the term “the bond pad is arranged within the substrate” may particularly denote a state where the bond pad is enclosed by the substrate such that the bond pad is not accessible from outside the substrate.

In the present context, the term “biocompatible electrode” may particularly denote an electrode made from a material which does not have a toxic or injurious effect on a biological substance, such as a biological sample to be analyzed. In other words, the biocompatible electrode will not react with the biological substance in such a way that unwanted reaction products are released to the biological substance, e.g. in the case of corrosion.

In the manufacturing method according to the first aspect, the first step resides in providing a substrate having a trench and a bond pad. The trench is filled with electrically conductive material such that the outer surface of the electrically conductive material is substantially coinciding with the surface of the substrate, i.e. the trench is substantially filled completely with electrically conductive material. The bond pad, which is also electrically conductive, is provided within the substrate, i.e. it is embedded in the substrate in such a way that it is at least covered by the surface of the substrate.

As a second step, a part of the electrically conductive material within the trench is removed in such a way that a recess is formed in the surface of the substrate. In other words, if it for purposes of illustration is assumed that the substrate is oriented such that the trench is provided in the upper surface of the substrate, this means that the electrically conductive material is removed from an upper portion of the trench.

As a third step, a biocompatible electrode is formed in the recess. More specifically, a biocompatible electrode material, i.e. a material that is both biocompatible and electrically conducting, is filled into the recess. The electrode may be formed such that it extends somewhat above the substrate surface, or such that its surface substantially coincides with the plane of the substrate surface, or such that its surface is slightly below the plane of the substrate surface. In the latter case, a part of the recess will remain after the electrode has been formed.

Finally, as a fourth step, a part of the substrate is removed in order to make the bond pad accessible through the resulting opening in the substrate. This step may preferably be formed by applying a dry etch process suitable for etching through the substrate material in a controllable manner.

Summarizing the above, it is noted that the manufacturing process may be considered as being divided into two main steps. The first main step serves to form the biocompatible electrode, and the second main step serves to provide a connection to the bond pad within the substrate. During the first main step, bond pad is embedded in the substrate such that it is not influenced by the forming of the biocompatible electrode. The final module can then be included in a biosensor e.g. by a packaging process which may include connecting a bond wire to the bond pad.

The manufacturing process according to the first aspect assures that the bond pad is not exposed to the processes involved in forming the biocompatible electrode. Thereby, corrosion of the bond pad during manufacture is prevented. Furthermore, the risk of corrosion of the bond pad during use of the manufactured module is reduced.

According to an embodiment, the step of removing a part of the electrically conductive material comprises an etching process and/or a chemical-mechanical planarization process. The etching process is preferably designed to etch a controllable amount of the electrically conductive material in the trench without significantly influencing the substrate.

According to a further embodiment, the step of forming a biocompatible electrode comprises (a) depositing an electrode material on the surface of the substrate in which surface the recess is formed, and (b) applying a chemical-mechanical planarization process to form the biocompatible electrode and to remove excessive electrode material from the surface of the substrate.

By depositing the electrode material on the surface of the substrate, the recess is filled with the electrode material such that the electrode material is in contact with the remaining electrically conductive material in the trench. By applying a chemical-mechanical planarization process, the electrode material is removed from the surface of the substrate while leaving a sufficient amount of the electrode material in the recess, such that the biocompatible electrode is formed. The specific chemical-mechanical planarization process is selected in dependence of the electrode material. According to a further embodiment, the biocompatible material comprises a noble metal, such as e.g. gold (Au) or platinum (Pt). The noble metal can be handled and processed by known processes and tools, and are non-toxic to biological material.

According to a further embodiment, the bond pad comprises a material selected from the group consisting of aluminum and copper. Furthermore, the electrically conductive material is selected from the group consisting of aluminum and copper.

Both aluminum (Al) and copper (Cu) have excellent electrical conductivity properties. Furthermore, they can be handled and processed by known processes and tools.

According to a further embodiment, the substrate comprises a further trench filled with the electrically conductive material, a part of the electrically conductive material is removed from the further trench such that a further recess is formed in the surface of the substrate, and a further biocompatible electrode is formed in the further recess.

In the present embodiment, the further biocompatible electrode is formed in the surface of the substrate in the same manner as the electrode is formed in the first aspect and the above described embodiments.

Thereby, two adjacent biocompatible electrodes are formed at essentially the same time. By having two electrodes, it becomes possible to measure desired properties at two positions within a biological sample. It is noted that more electrodes may be provided in a similar manner. Thereby, a variety of sensor structures can be obtained, such as a linear structure, i.e. a row of adjacent electrodes, a matrix structure, i.e. a plurality of parallel rows of electrodes, or any other desirable electrode pattern structure.

According to a second aspect, there is provided a module for a biosensor. The described module comprises (a) a substrate comprising (i) a trench, (ii) a bond pad, and (iii) a cut-out portion, and (b) a biocompatible electrode. Further, the trench contains an electrically conductive material in a lower portion of the trench, the biocompatible electrode is formed in an upper portion of the trench and is in contact with the electrically conductive material in the lower portion of the trench, and the bond pad is arranged within the substrate and is accessible through the cut-out portion.

The module according to this aspect is preferably manufactured by means of the method according to the first aspect or any of the above embodiments. Accordingly, the module according to this aspect has the advantage that the bond pad has not been exposed to the processes involved in forming the biocompatible electrode. Thus, the risk that the bond pad is corroded is minimal.

In the present context, the term “upper portion” may particularly denote a portion of the trench which is closer to the surface of the substrate. Similarly, the term “lower portion” may particularly denote a portion of the trench which is farther away from the surface of the substrate in comparison to the “upper portion”.

In the present context, the term “accessible” may in particular denote that that a bonding wire may be brought into contact with the bond pad through the cut-out portion.

It is noted that the biocompatible electrode and the bond pad may be electrically connected to suitable electronic components supported by the substrate. Such electronic components may in particular be designed to provide functions suitable for biosensor applications, such as signal amplification, filtering and interfacing.

According to an embodiment, the module comprises a further biocompatible electrode, the substrate comprises a further trench which contains electrically conductive material in a lower portion thereof, and the further biocompatible electrode is formed in an upper portion of the further trench and is in contact with the electrically conductive material in the lower portion of the further trench.

By having two electrodes, it becomes possible to measure desired properties at two positions within a biological sample. It is noted that the sensor module may comprise even more electrodes.

According to a further embodiment, the further biocompatible electrode is arranged adjacent to and electrically isolated from the biocompatible electrode.

By having two adjacent and electrically isolated biocompatible electrodes on the same surface of the substrate, variations in the properties of a biological substance to be measured at spatially nearby positions can be detected. As mentioned above, the module may comprise more than two electrodes which may be arranged in any desired pattern on the substrate surface, including e.g. a linear structure and a matrix structure.

According to a further embodiment, the biocompatible electrode comprises a noble metal.

Albeit being expensive, noble materials, such as gold and platinum, are known to have excellent biocompatibility.

According to a further embodiment, the biocompatible electrode is coated with a bioreceptor.

In the present context, the term “bioreceptor” may particularly denote a material with a certain property in relation to a biological material to be analyzed. For example, the bioreceptor may be a material that attracts certain molecules within a sample of a biological fluid, such as glucose molecules in a blood sample.

According to a third aspect, there is provided a biosensor. The described biosensor comprises a module according to the second aspect or any of the above embodiments thereof

Accordingly, the biosensor according to this aspect will be of high quality, in particular it will have a very low risk of corrosion.

According to a fourth aspect, there is provided a computer program comprising computer executable instructions which when executed by a computer causes the computer to perform the steps of the method according to the first aspect or any of the above described embodiments thereof.

More specifically, the computer program may be suitable for controlling the machinery and chemical processes involved in the manufacturing method, such that the biosensor modules can be manufactured in an automatic or at least semiautomatic manner.

According to a fifth aspect, there is provided a computer program product comprising a computer readable data carrier loaded with a computer program according to the fourth aspect.

It is noted that embodiments of the invention have been described with reference to different subject matters. In particular, some embodiments have been described with reference to method type claims whereas other embodiments have been described with reference to apparatus type claims. However, a person skilled in the art will gather from the above and the following description that, unless otherwise indicated, in addition to any combination of features belonging to one type of subject matter also any combination of features relating to different subject matters, in particular a combination of features of the method type claims and features of the apparatus type claims, is part of the disclosure of this document.

The aspects defined above and further aspects of the present invention are apparent from the examples of embodiment to be described hereinafter and are explained with reference to the examples of embodiment. The invention will be described in more detail hereinafter with reference to examples of embodiment to which the invention is, however, not limited.

### BRIEF DESCRIPTION OF THE DRAWING

FIGS. 1A to 1E illustrates the steps of a manufacturing method in accordance with the prior art.

FIGS. 2A to 2E illustrates the steps of a manufacturing method in accordance with an embodiment.

### DETAILED DESCRIPTION

The illustration in the drawing is schematic. It is noted that in different figures, similar or identical elements are provided with the same reference signs or with reference signs, which differ only within the first digit.

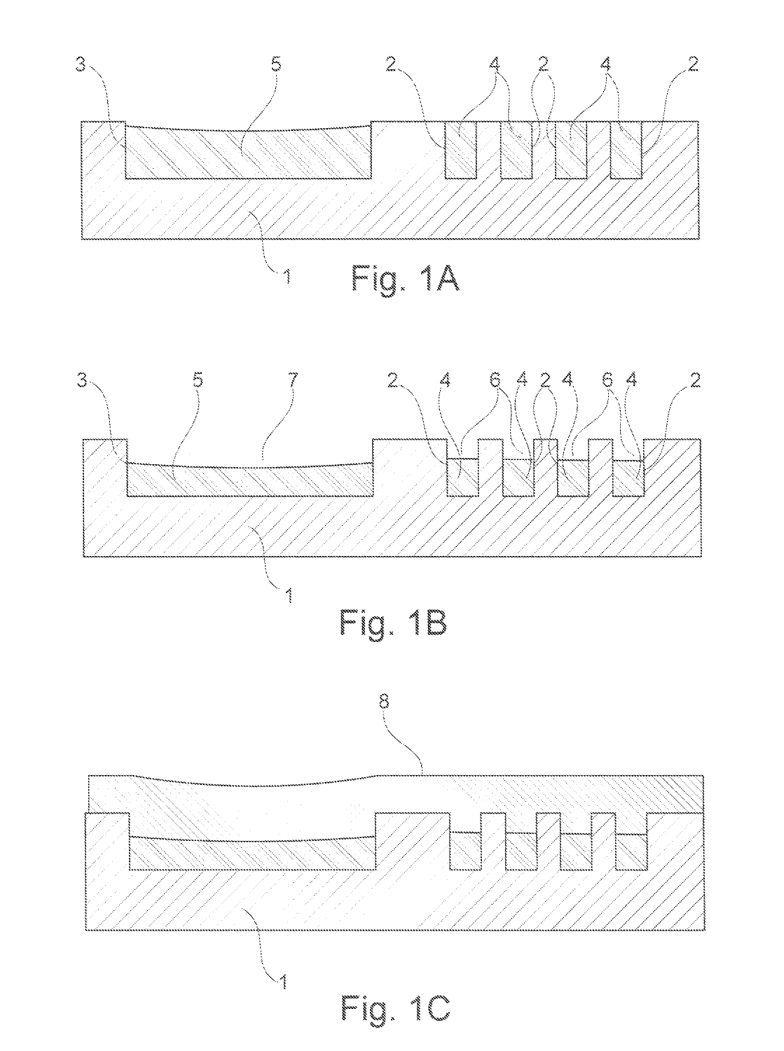

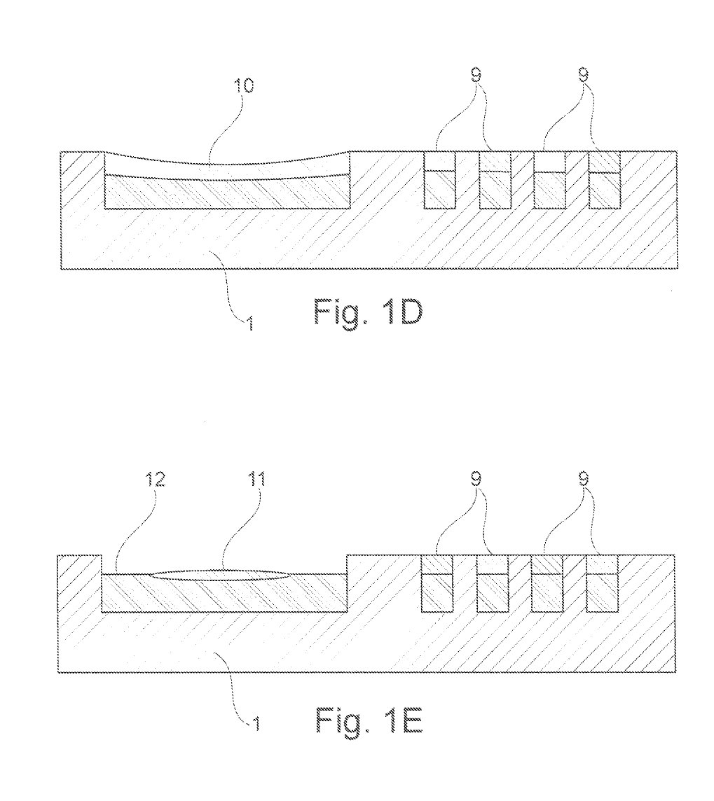

FIGS. 1A to 1E illustrate the steps of a manufacturing method in accordance with the prior art and some of the problems associated therewith.

More specifically, FIG. 1A shows an initial stage of the prior art manufacturing process. A dielectric substrate 1 comprising four narrow trenches 2 and a wide trench 3 is provided. The narrow trenches 2 are filled with copper 4 intended for providing electrical connection between biocompatible electrodes yet to be formed and electrical and electronic components (not shown) supported by the substrate 1. Similarly, the wide trench 3 is filled with copper 5 intended to form a bond pad for connecting to external devices (not shown).

In a first processing step, a part of the copper 4 in the narrow trenches 2 and a part of the copper 5 in the wide trench 3 is removed by means of a copper etch back process. Thereby, as shown in FIG. 1B, recesses 6 above the remaining copper 4 in the narrow trenches 2 are formed. Further, as also shown in FIG. 1B, a recess 7 is formed above the remaining copper in the wide trench 3.

Then, in a second processing step, a layer 8 of gold is deposited on the structure, resulting in the structure shown in FIG. 1C.

Thereafter, a chemical-mechanical planarization (CMP) process is applied with the aim of obtaining the structure shown in FIG. 1D, where gold electrodes 9 are formed in the upper part of the narrow trenches 2 and a bond pad electrode 10 is formed in the upper part of the wide trench 3 while excessive gold is removed from the upper surface of the substrate 1.

However, due to various reasons, such as the difference in size between the narrow trenches 2 and the wide trench 3, the resulting structure may likely differ from the desired structure of FIG. 1D.

FIG. 1E shows an example of an undesirable structure which is likely to be obtained instead of the one illustrated in FIG. 1D. The structure shown in FIG. 1E differs from that of FIG. 1D in that the deposited gold 8 is completely removed from a part 12 of the copper in the wide trench 3 while another part of the copper is covered by the remaining gold 11. In this structure, the part 12 of the copper is exposed to the chemicals involved in the CMP process and therefore corrodes immediately. This corrosion makes the resulting sensor module unusable.

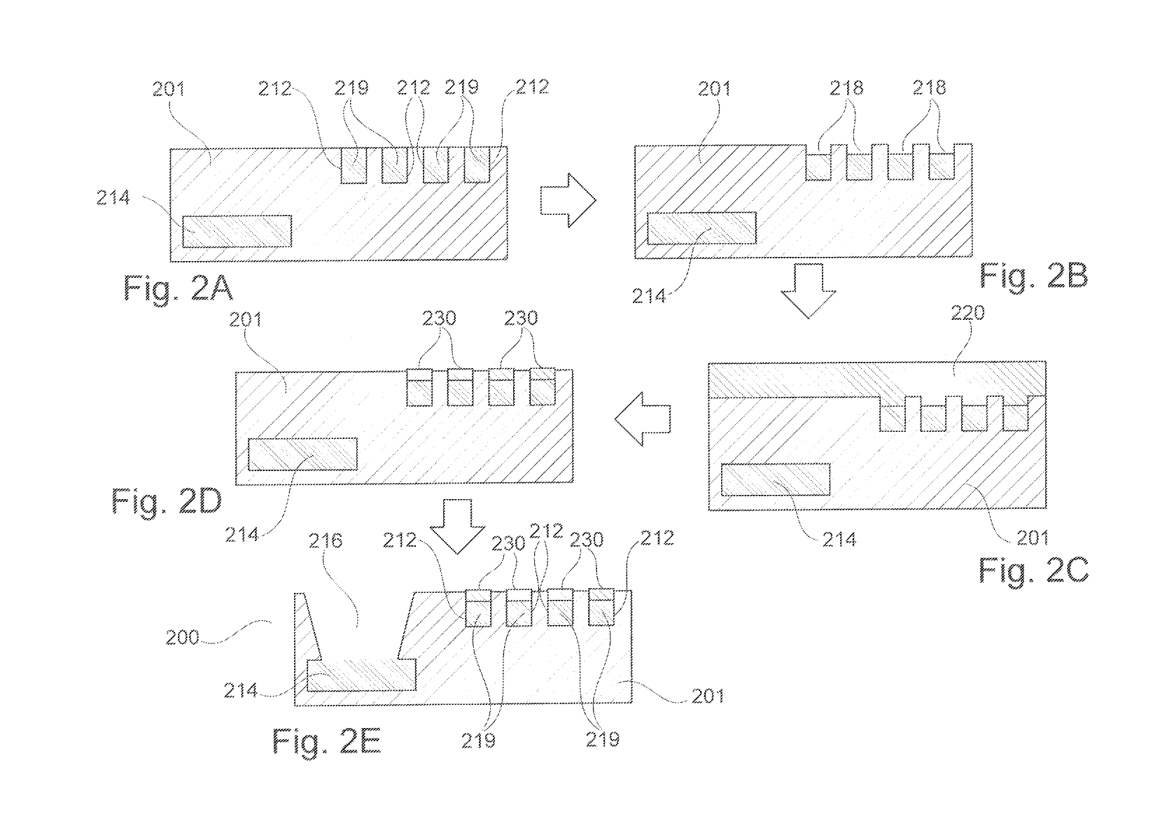

FIGS. 2A to 2E illustrate the steps of a manufacturing method in accordance with an embodiment of the present invention.

More specifically, FIG. 2A shows an initial stage of the manufacturing process according to the present embodiment. A dielectric substrate 201 is provided. The dielectric substrate 201 comprises trenches 212 and a bond pad 214. The trenches 212 are filled with copper 219 (or another suitable conductive material, such as Tungsten (W)) intended for providing electrical connection between biocompatible electrodes yet to be formed and electrical and electronic components (not shown) supported by the substrate 201. The bond pad 214 is provided within the substrate 201 and comprises e.g. Aluminum. Further, as can be seen, the bond pad 214 is arranged below and to the side (left in the drawing) relative to the trenches 212. It should be noted that the drawing shows a cross-section such that the trenches 212 and the bond pad 214 extend in the direction perpendicular to the plane of the drawing.

In a first processing step, a part of the copper 219 in the trenches 212 is removed by means of a copper etch back process. Thereby, as shown in FIG. 1B, recesses 218 are formed above the remaining copper in the trenches 212. The copper etch back process is similar to the one applied in the prior art process described above with reference to FIGS. 1A to 1E. However, as can be seen in FIG. 2B, the bond pad 214 is protected by the substrate 201 and therefore not exposed to the etch back process. Then, in a second processing step, a layer 220 of gold is deposited on top of the structure, resulting in the structure shown in FIG. 2C.

Thereafter, a chemical-mechanical planarization (CMP) process is applied to form gold electrodes 230 in the upper part of the trenches 212 on top of the remaining copper 219 as shown in FIG. 2D. More specifically, the CMP process forms the electrodes 230 and removes excess gold from the surface of the substrate 201 such that the electrodes are electrically isolated from each other. It is noted that in contrast to the prior art process shown in FIGS. 1A to 1E and described above, the bond pad 214 is not exposed to the CMP process. Accordingly, the electrodes 230 are formed without the risk of causing corrosion in the bond pad 214.

However, due to various reasons, such as the difference in size between the narrow trenches 2 and the wide trench 3, the resulting structure may likely differ from the desired structure of FIG. 1D.

Finally, the process is finished by etching down through the substrate 201 from above the bond pad 214 such that an opening 216 is formed in the substrate 201 which allows access to the bond pad 214, e.g. in order to connect a bonding wire (not shown). The resulting biosensor module is shown in FIG. 2E.

It is noted that, unless otherwise indicated, the use of terms such as “upper”, “lower”, “left”, and “right” refers solely to the orientation of the corresponding drawing.

It should be noted that the term “comprising” does not exclude other elements or steps and that the use of the articles “a” or “an” does not exclude a plurality. Also elements described in association with different embodiments may be combined. It should also be noted that reference signs in the claims should not be construed as limiting the scope of the claims.

1. A method of manufacturing a module for a biosensor, the method comprising
providing a substrate, the substrate comprising a trench and a bond pad, wherein the trench is filled with an electrically conductive material and the bond pad is arranged within the substrate,
removing a part of the electrically conductive material from the trench such that a recess is formed in a surface of the substrate,
forming a biocompatible electrode in the recess, and
removing a part of the substrate such that the bond pad is accessible through the surface of the substrate.

2. The method according to claim 1, wherein the step of removing a part of the electrically conductive material comprises an etching process and/or a chemical-mechanical planarization process.

3. The method according to claim 1, wherein the step of forming a biocompatible electrode comprises
depositing an electrode material on the surface of the substrate in which the recess is formed, and
applying a chemical-mechanical planarization process to form the biocompatible electrode and to remove excessive electrode material from the surface of the substrate

4. The method according to claim 1, wherein the biocompatible material comprises a noble metal.

5. The method according to claim 1, wherein the bond pad comprises a material selected from the group consisting of aluminum and copper, and wherein the electrically conductive material is selected from the group consisting of aluminum and copper.

6. The method according to claim 1, wherein
the substrate comprises a further trench filled with the electrically conductive material,
a part of the electrically conductive material is removed from the further trench such that a further recess is formed in the surface of the substrate, and
a further biocompatible electrode is formed in the further recess.

7. A module for a biosensor, the module comprising
a substrate comprising a trench, a bond pad, and a cut-out portion, and
a biocompatible electrode,
wherein the trench contains an electrically conductive material in a lower portion of the trench the biocompatible electrode is formed in an upper portion of the trench and is in contact with the electrically conductive material in the lower portion of the trench, and wherein the bond pad is arranged within the substrate and is accessible through the cut-out portion.

8. The module according to claim 7, comprising
a further biocompatible electrode,
wherein the substrate-comprises a further trench which contains electrically conductive material in a lower portion thereof, and the further biocompatible electrode is formed in an upper portion of the further trench and is in contact with the electrically conductive material in the lower portion of the further trench.

9. The module according to claim 7, wherein the further biocompatible electrode is arranged adjacent to and electrically isolated from the biocompatible electrode.

10. The module according to claim 7, wherein the biocompatible electrode comprises a noble metal.

11. The module according to claim 7, wherein the biocompatible electrode is coated with a bioreceptor.

12. A biosensor comprising a module according to claim 7.

13. A computer program comprising computer executable instructions which when executed by a computer causes the computer to perform the steps of the method according to claim 1.

14. A computer program product comprising a computer readable data carrier loaded with a computer program according to claim 13.
